(19) United States
(12) Patent Application Publication
(10) Pub. No.: US 2005/0046162 A1
(43) Pub. Date: Mar. 3, 2005

(54) Gas bag module for a vehicle occupant protection system

(75) Inventor: Matthias Helmstetter, Aschaffenburg (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 10/894,460

(22) Filed: Jul. 19, 2004

(30) Foreign Application Priority Data
Aug. 28, 2003 (DE) 203 13 367.6

(51) Int. Cl. B60R 21/30

(52) U.S. Cl. 280/739

(57) ABSTRACT

A gas bag module for a vehicle occupant protection system includes a gas bag (12) and a module covering cap (14). The gas bag (12) has at least one outflow opening (20). The covering cap (14) includes at least one section (16), which is flapped open on unfolding of the gas bag (12). The outflow opening (20) is formed in a region which, in the unfolded state of the gas bag (12), lies opposite the flapped open section (16) of the covering cap (14).

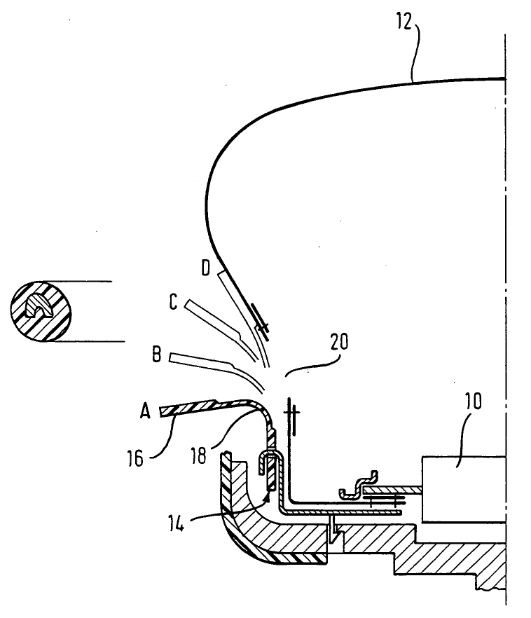

### TECHNICAL FIELD

The invention relates to a gas bag module for a vehicle occupant protection system.

### BACKGROUND OF THE INVENTION

Conventional driver's gas bag modules are known which comprise a gas bag having at least one outflow opening, and a module covering cap including at least one section which is flapped open on unfolding of the gas bag. To avoid fire injuries to the vehicle occupant, outflow openings are arranged in the gas bag so that after the filling of the gas bag (in particular when the occupant strikes onto the gas bag), an outflow of the hot filling gas is directed either directly into the gas bag module or into the free region between gas bag module and steering wheel rim. In such gas bag modules, an increased expenditure must be made in order to actually rule out a fire injury to the occupant in all steering wheel positions and in order to avoid possible impairments to function, which can arise if owing to the high component density in the gas bag module or the gap situation between gas bag module and steering wheel rim, the gas can not flow out unimpeded.

### SUMMARY OF THE INVENTION

The invention provides a gas bag module in which the reliability of operation and the protection from fire injuries on outflow of the filling gas can be ensured without a great expenditure.

The gas bag module for a vehicle occupant protection system according to the invention comprises a gas bag having at least one outflow opening, and a module covering cap including at least one portion which is flapped open on unfolding of the gas bag. According to the invention, the outflow opening is formed in a region which, in the unfolded state of the gas bag, lies opposite the flapped-open portion of the covering cap. Through the particular arrangement of the outflow opening, the gas is intentionally directed to the flapped-open portion of the covering cap, whereby a controlled, dosed outflow of the filling gas is made possible. As the outflowing gas firstly strikes onto the flapped-open portion of the covering cap, the risk of fire injury for the occupant is minimized.

Preferably, the portion which is able to be flapped open has a hinge region. This development has the advantage that through an appropriate construction of the hinge region, in particular through the setting of the rigidity, the dynamic outflow behaviour can be influenced in line with specific objectives.

At least the hinge region of the portion which is able to be flapped open is preferably made of plastic. This contributes to the improvement of the restraining effect of the gas bag even at extreme temperature conditions, because the outflow behaviour is automatically controlled in a desired manner by the temperature-dependent inherent rigidity of the plastic. Thus, at very low temperatures, at which the gas generator output is noticeably reduced, the plastic of the hinge region is so rigid that the portion assumes a less widely flapped open position and hence covers the outflow opening to a greater extent. Thereby, the filling gas remains longer in the gas bag and a premature pressure decrease in the gas bag is avoided. The reverse applies for the outflow behaviour at extremely high temperatures at which, through the further flapping open of the section, a faster outflow of the filling gas is made possible, to avoid an excessively high internal pressure of the gas bag.

### BRIEF DESCRIPTION OF THE DRAWING

In the drawing, the single FIGURE shows a half of a gas bag module according to the invention, with an unfolded gas bag, in a sectional view.

### DETAILED DESCRIPTION OF A PREFERRED EMBODIMENT

The gas bag module illustrated in the FIGURE comprises a gas generator 10, by which a gas bag 12 can be filled, and a module covering cap 14 of plastic. The covering cap 14 has sections 16, able to be flapped open in a known manner, which are detachably connected with each other, so that the gas bag 12 can unfold out from the module. The flapping open of the covering cap 14 is made possible by hinge regions 18 of the sections 16, which have a smaller material thickness (“hinging” of the covering cap 14). The gas bag 12 has lateral outflow openings 20 which—in relation to the unfolded state of the gas bag 12—are respectively arranged in regions of the gas bag 12 which lie opposite the sections 16, in particular their hinge regions 18.

If, as needed, the gas bag 12 is filled with the gas provided by the gas generator 10, the module covering cap 14 opens by the sections 16 being flapped open to the side. In so doing, firstly an overswinging of the sections 16 occurs up to a position designated by A in the FIGURE, in which there is no covering of the outflow openings 20 by the flapped-open sections 16. Depending on how rigid the hinge regions 18 are formed, the sections 16 then move back to a greater or lesser extent (positions B, C), possibly up to abutment against the wall of the gas bag 12 (position D). Each portion 16 therefore acts as a kind of valve for the gas escaping through the outflow openings 20, the degree of covering of the outflow openings 20 and hence the resistance offered to the outflowing gas, depending on the rigidity of the hinge regions 18. This leads to a dynamic outflow, in which the gas which is still hot, emerging form the gas bag 12, firstly strikes onto the sections 16, before it distributes itself further in the surrounding space.

1. A gas bag module for a vehicle occupant protection system, the gas bag module comprising
a gas bag (12) having at least one outflow opening (20), and
a module covering cap (14) including at least one portion (16) which is flapped open on unfolding of the gas bag (12),
characterized in that the outflow opening (20) is formed in a region which, in the unfolded state of the gas bag (12), lies opposite the flapped-open portion(16) of the covering cap (14).

2. The gas bag module according to claim 1, characterized in that the portion (16) of the covering cap (14), which is able to be flapped open, has a hinge region (18).

3. The gas bag module according to claim 2, characterized in that at least the hinge region (18) of the portion (l6), which is able to be flapped open, is made of plastic.

4. The gas bag module according to claim 2, characterized in that the outflow opening (20) lies opposite the hinge region (18).

5. The gas bag module according to claim 4, characterized in that the portion (16), which is able to be flapped open, in the unfolded state of the gas bag (12) abuts a wall of the gas bag (12).
